(19) United States
(12) Patent Application Publication
(10) Pub. No.: US 2010/0138678 A1
(43) Pub. Date: Jun. 3, 2010

(54) POWER-SAVING DEVICE FOR POWER OVER ETHERNET AND CONTROL METHOD THEREFOR

(75) Inventor: YING-HUI HUANG, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: Alpha Networks Inc., Hsinchu (TW)

(21) Appl. No.: 12/629,431

(22) Filed: Dec. 2, 2009

(30) Foreign Application Priority Data
Dec. 3, 2008 (TW) 097147015

(51) Int. Cl. G06F 1/32

(52) U.S. Cl. 713/320

(57) ABSTRACT

A power-saving device for use with a Power-over-Ethernet technology includes a plurality of connecting ports, a time generator, a storage medium, a power control unit, and a micro controller. The connecting ports are electrically connected with respective powered devices for transmitting electrical power and data to respective powered devices. The time generator is used for generating time information. The storage medium is used for storing a power schedule table. The power control unit is electrically connected with the connecting ports for transmitting electrical power to the connecting ports. The micro controller is connected with the time generator, the storage medium and the power control unit. According to the power schedule table read out from the storage medium by the micro controller and the time information generated by the time generator, a power-outputting status of the power control unit is controlled by the micro controller.

### FIELD OF THE INVENTION

The present invention relates to a power-saving device and a power-saving method for use with a Power-over-Ethernet technology, and more particularly to a power-saving device and a power-saving method for use with a Power-over-Ethernet technology according to a predetermined power schedule.

### BACKGROUND OF THE INVENTION

A Power-over-Ethernet (PoE) technology is a technology that transmits electrical power and data to remote devices over standard twisted-pair cables in an Ethernet network. The PoE technology simplifies installation of the power source and eliminates the need of using costly and cumbersome AC outlets. By using the PoE technology, the time and cost associated with the installation and maintenance of the power source are reduced. Since the number of cables is reduced, the power management station using the PoE technology is economical and user-friendly.

There are two types of PoE hardware devices, i.e. a power sourcing equipment (PSE) and a powered device (PD). The power sourcing equipment provides electrical power to the powered device that is connected with the Ethernet network. The powered device receives electrical power through the Ethernet network. An example of the power sourcing equipment includes a Power-over-Ethernet (PoE) switch. The powered device receiving electrical power through the Ethernet network is also referred as a Power-over-Ethernet (PoE) powered device. An example of the PoE powered device includes an IP-Camera (internet protocol camera), a VoIP (Voice over Internet Protocol) phone, a wireless AP (wireless access point), or the like.

FIG. 1 is a schematic functional block diagram illustrating a Power-over-Ethernet system according to the prior art. As shown in FIG. 1, a first terminal of a Power-over-Ethernet (PoE) switch 104 is connected to a network management station 102, and a second terminal of the PoE switch 104 is connected to a plurality of powered devices through corresponding separate connecting ports. The PoE switch 104 has PoE function. The powered devices include for example a wireless AP (wireless access point) 108, a VoIP (Voice Over Internet Protocol) phone 109 and an IP-camera (internet protocol camera) 110. The connecting ports include a first connecting port 105, a second connecting port 106 and a third connecting port 107. Under control of a power control unit 103, the PoE switch 104 transmits electrical power and data to the powered devices 108, 109 and 110 through the connecting ports 105, 106 and 107, respectively.

The conventional Power-over-Ethernet technology, however, still has some drawbacks. In a case that these powered devices are idle or not in use, the PoE switch 104 may continuously transmit electrical energy to these powered devices 108, 109 and 110. For interrupting transmission of electrical power to the powered devices 108, 109 and 110, the user should manually turn off the main power source of the PoE switch 104 or electrically disconnect the connecting ports 105, 106 and 107 from the powered devices 108, 109 and 110. For example, in the off-duty time, weekends or holidays, the VoIP phones of a company are usually not used, it is better to interrupt transmission of electrical power to these VoIP phones in order to reduce power consumption. As known, the process of manually or successively interrupting the electrical connection between the VoIP phones and respective connecting ports is very troublesome and inconvenient. As the number of VoIP phones is increased, the problem becomes more serious. Due to the complicated process of manually interrupting the power transmission, most companies would rather allow the PoE switch 104 to continuously transmit electrical power to the powered devices.

Therefore, there is a need of providing a power-saving device and a power-saving method for use with a Power-over-Ethernet technology so as to obviate the drawbacks encountered from the prior art.

### SUMMARY OF THE INVENTION

The present invention provides a power-saving device and a power-saving method for use with a Power-over-Ethernet technology according to a predetermined power schedule, thereby achieving power-saving and cost-effective purposes.

In accordance with an aspect of the present invention, there is provided a power-saving device for use with a Power-over-Ethernet technology. The power-saving device transmits electrical power and data to a plurality of powered devices. The power-saving device includes a plurality of connecting ports, a time generator, a storage medium, a power control unit, and a micro controller. The connecting ports are electrically connected with respective powered devices for transmitting electrical power and data to respective powered devices. The time generator is used for generating time information. The storage medium is used for storing a power schedule table. The power control unit is electrically connected with the connecting ports for transmitting electrical power to the connecting ports. The micro controller is connected with the time generator, the storage medium and the power control unit. The power schedule table can be controlled by either a network management station or be preloaded/programmed through a network server. According to the power schedule table read out from the storage medium by the micro controller and the time information generated by the time generator, a power-outputting status of the power control unit is controlled by the micro controller.

In accordance with another aspect of the present invention, there is provided a power-saving device for use with a Power-over-Ethernet technology. The power-saving device transmits electrical power and data to at least one powered device. The power-saving device includes at least one connecting port, a time generator, a storage medium, a power control unit, and a micro controller. The connecting port is electrically connected with the powered device for transmitting electrical power and data to the powered device. The time generator is used for generating time information. The storage medium is used for storing a power schedule table. The power control unit is electrically connected with the connecting port for transmitting electrical power to the connecting port. The micro controller is connected with the time generator, the storage medium and the power control unit. According to the power schedule table read out from the storage medium by the micro controller and the time information generated by the time generator, a power-outputting status of the power control unit is controlled by the micro controller.

In accordance with a further aspect of the present invention, there is provided a power-saving method. The power-saving method includes steps of reading out a power schedule table, reading time information, and controlling a power-outputting status of the power control unit according to the power schedule table and the time information.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a Power-over-Ethernet system according to the prior art;

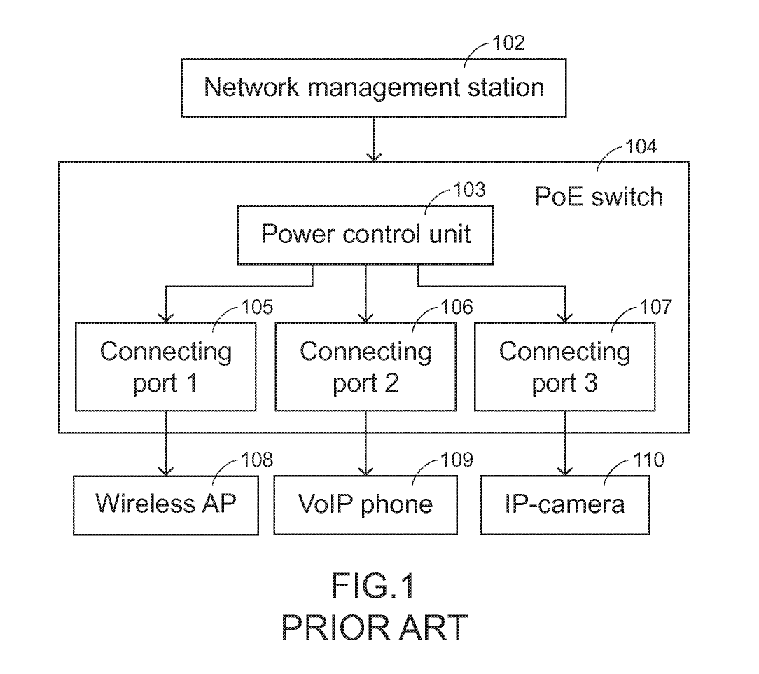

FIG. 2 is a schematic functional block diagram illustrating a power-saving device for use with a Power-over-Ethernet technology according to an embodiment of the present invention; and

FIG. 3 is flowchart illustrating a power-saving method for use with a Power-over-Ethernet technology according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

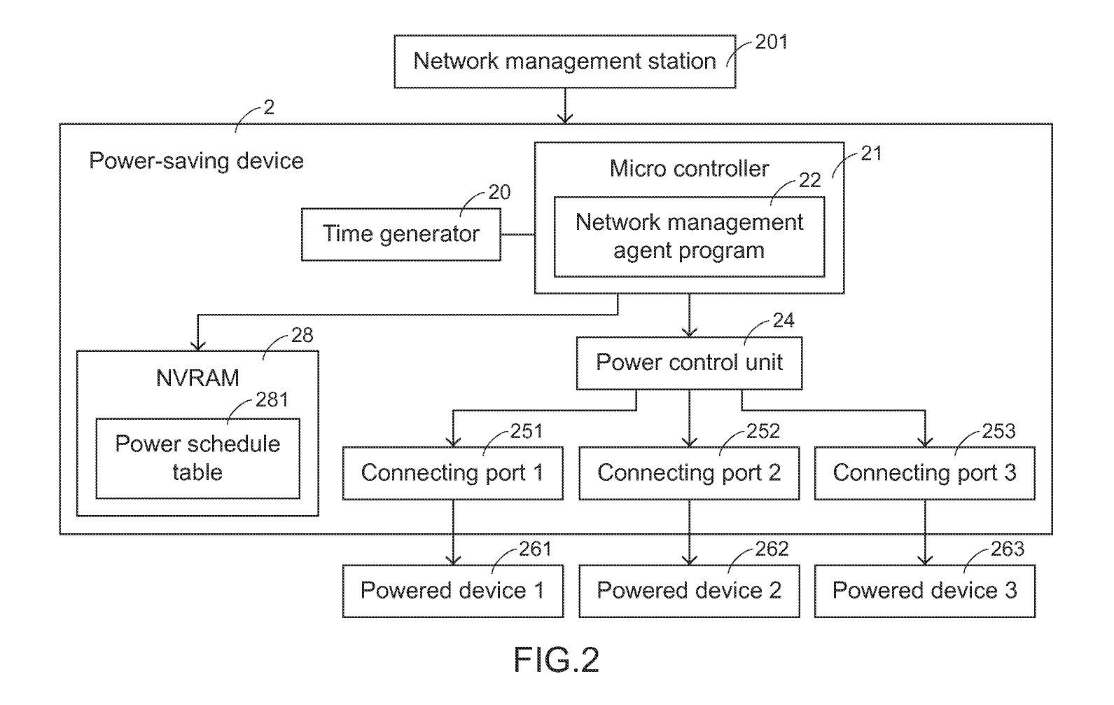

FIG. 2 is a schematic functional block diagram illustrating a power-saving device for use with a Power-over-Ethernet technology according to an embodiment of the present invention. As shown in FIG. 2, the power-saving device 2 for use with the PoE technology comprises a time generator 20, a non-volatile random access memory (NVRAM) 28, a power control unit 24, a micro controller 21, and a plurality of separate connecting ports 251, 252 and 253. The time generator 20 is used for generating time information. The micro controller 21 is connected with the time generator 20, the non-volatile random access memory 28 and the power control unit 24. The connecting ports 251, 252 and 253 are electrically connected with the power control unit 24. Under control of the power control unit 24, electrical power and data are transmitted to the powered devices 261, 262 and 263 through the connecting ports 251, 252 and 253, respectively. Examples of these powered devices 261, 262 and 263 include network devices such as wireless access points, VoIP phones and IP-cameras. A network management agent program 22 is executed in the micro controller 21. The network management agent program 22 is acted as an agent terminal of the network management station 201. The network management station 201 may be equipped with network communication protocol to work with network management agent program 22 to remotely control the power-saving device 2, for example to set up a power schedule table. For example, data and control signals could be transmitted from the manager terminal to the agent terminal or vice verse the agent terminal can make responses to the management station for the equipment conditions and the power-supplying conditions of the power-saving device 2.

Furthermore, a power schedule table 281 is stored in a non-volatile memory device, for example, the non-volatile random access memory 28. According to the time information generated by the time generator 20 and the power schedule table 281, the network management agent program 22 will control the power-outputting status of the power control unit 24. In a first power-outputting status, the power control unit 24 implements a power-supplying task to transmit electrical power to these separate connecting ports 251, 252 and 253. Whereas, in a second power-outputting status, the power control unit 24 implements a power-interrupting task to interrupt transmission of electrical power to these separate connecting ports 251, 252 and 253. In other words, the network management agent program 22 is an important control core of the power-saving device 2.

The power schedule table 281 could be set by the user and defined in minutes, seconds, and hours on a weekly basis or a daily basis. That is, the weekly power schedule or the daily power schedule of the power-saving device 2 could be set in the power schedule table 281. The power schedule table 281 includes the scheduled time (e.g. the date or time) of outputting electrical power from the power control unit 24 to the separate connecting ports 251, 252 and 253 and/or the quantity of electricity to be outputted.

For example, in a case that a daily power schedule of the power-saving device 2 includes a power-supplying task at 10:00 a.m. and a power-interrupting task at 6:30 p.m., the power-saving device 2 will implement the power-supplying task and the power-interrupting task at the scheduled time. Moreover, in order to meeting diverse demands, the scheduled tasks to be implemented at the schedule time could be different for different connecting ports. For example, for a first connecting port, a daily power schedule includes a power-supplying task at 8:00 a.m. and a power-interrupting task at 5:30 p.m.; and for a second connecting port, a weekly power schedule includes a power-supplying task at 9:00 a.m. and a power-interrupting task at 10:30 p.m. in every Monday, Wednesday and Friday. Since the power schedule table 281 could be set according to the demand of the user or the supervisor, the timing of transmitting power to the powered devices is effectively managed in order to achieve power-saving and cost-effective purposes. The power schedule table 281 could be set by the user via the network management station 201 or a network server. After the power schedule table 281 is set, the power schedule table 281 is transmitted to the network management agent program 22. After the power schedule table 281 is received by the network management agent program 22, the power schedule table 281 is stored in the non-volatile random access memory 28. An example of the non-volatile random access memory 28 includes but is not limited to a flash memory or an electrically erasable programmable read-only memory (EEPROM). Even if the power-saving device 2 is powered off, the data stored in the non-volatile random access memory 28 will not be lost.

The time generator 20 could generate the time information associated with the location of the power-saving device 2 or any other location of the world. In an embodiment, the time generator 20 generates the time information associated with the location of the power-saving device 2. An example of the time generator 20 is a real time clock (RTC). The real time clock is usually used in a computer system to keep track of the current time. According to the time information, the network management agent program 22 will realize the current time. According to the time information and the predetermined power schedule stored in the power schedule table 281, the power-outputting status of transmitting power from the power control unit 24 to the connecting ports 251, 252, 253 is controlled by the network management agent program 22.

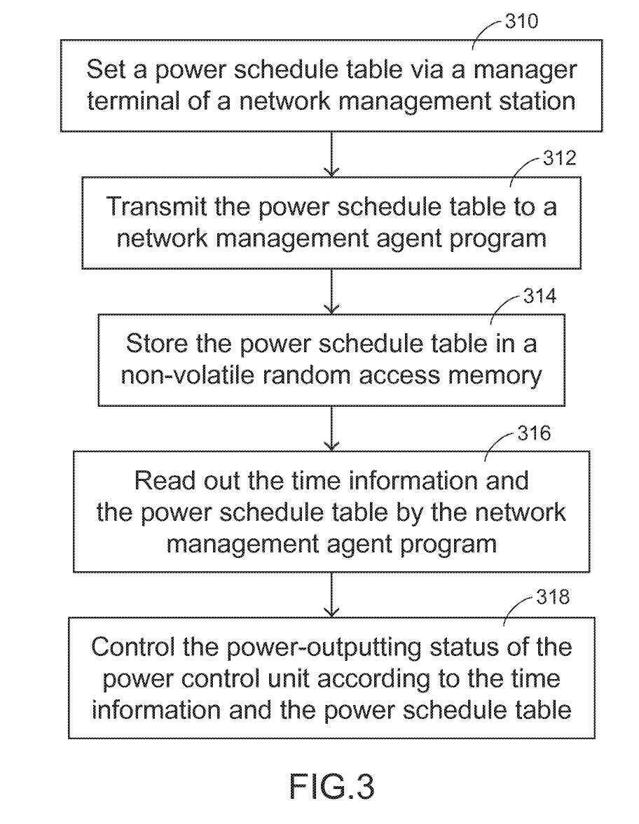

FIG. 3 is flowchart illustrating a power-saving method for use with a Power-over-Ethernet technology according to an embodiment of the present invention. Hereafter, the power-saving method of the present invention will be illustrated in more details with reference to the functional block diagram of FIG. 2 and the flowchart of FIG. 3. First of all, a power schedule table 281 is set via the manager terminal of the network management station 201 (Step 310). Next, the power schedule table 281 is transmitted to the network management agent program 22 (Step 312). After the power schedule table 281 is received by the network management agent program 22, the power schedule table 281 is stored in the non-volatile random access memory 28 (Step 314). Since the power schedule table 281 is stored in the non-volatile random access memory 28, the possibility of causing data loss of the power schedule table 281 will be avoided in a case that the power provided to the power-saving device 2 is suffered from interruption. Next, the time information generated by the time generator 20 is transmitted to the network management agent program 22 and the power schedule table 281 is read out by the network management agent program 22 (Step 316). According to the time information and the power schedule table 281, the power-outputting status of the power control unit 24 is controlled by the network management agent program 22 (Step 318). For example, under control of the network management agent program 22, the power control unit 24 transmits electrical power to these separate connecting ports 251, 252 and 253 in a first power-outputting status or interrupts transmission of electrical power to these separate connecting ports 251, 252 and 253 in a second power-outputting status.

From the above description, the present invention provides a power-saving device and a power-saving method for use with a Power-over-Ethernet technology. According to the time information generated by a time generator and a scheduled time predetermined in a power schedule table, the power-outputting status of the power control unit is controlled by the network management agent program. As a consequence, the power-saving device and the power-saving method of the present invention are capable of effectively managing the timing of transmitting power to the powered devices while achieving power-saving and cost-effective purposes.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power-saving device for use with a Power-over-Ethernet technology, the power-saving device transmitting electrical power and data to a plurality of powered devices, the power-saving device comprising:
a plurality of connecting ports electrically connected with respective powered devices for transmitting electrical power and data to respective powered devices;
a time generator for generating time information;
a storage medium for storing a power schedule table;
a power control unit electrically connected with the connecting ports for transmitting electrical power to the connecting ports; and
a micro controller connected with the time generator, the storage medium and the power control unit, wherein according to the power schedule table read out from the storage medium by the micro controller and the time information generated by the time generator, a power-outputting status of the power control unit is controlled by the micro controller.

2. The power-saving device according to claim 1 wherein the storage medium is a non-volatile memory device.

3. The power-saving device according to claim 1 wherein the power schedule table is adjustable by a user, and includes the date or time of outputting electrical power from the power control unit to the connecting ports or the quantity of electricity to be outputted.

4. The power-saving device according to claim 1 wherein a network management agent program is executed in the micro controller, and the power-outputting status of the power control unit is controlled by the network management agent program according to the power schedule table and the time information.

5. The power-saving device according to claim 1 wherein the time generator generates the time information associated with the location of the power-saving device.

6. The power-saving device according to claim 1 wherein the time generator is a real time clock.

7. The power-saving device according to claim 1 wherein the power control unit transmits electrical power to the connecting ports according to the power-outputting status of the power control unit.

8. The power-saving device according to claim 1 wherein the power control unit interrupts transmission of electrical power to the connecting ports according to the power-outputting status of the power control unit.

9. A power-saving device for use with a Power-over-Ethernet technology, the power-saving device transmitting electrical power and data to at least one powered device, the power-saving device comprising:
at least one connecting port electrically connected with the powered device for transmitting electrical power and data to the powered device;
a time generator for generating time information;
a storage medium for storing a power schedule table;
a power control unit electrically connected with the connecting port for transmitting electrical power to the connecting port; and
a micro controller connected with the time generator, the storage medium and the power control unit, wherein according to the power schedule table read out from the storage medium by the micro controller and the time information generated by the time generator, a power-outputting status of the power control unit is controlled by the micro controller.

10. The power-saving device according to claim 9 wherein the storage medium is a non-volatile memory device.

11. The power-saving device according to claim 9 wherein the power schedule table is adjustable by a user, and includes the date or time of outputting electrical power from the power control unit to the connecting ports or the quantity of electricity to be outputted.

12. The power-saving device according to claim 9 wherein a network management agent program is executed in the micro controller, and the power-outputting status of the power control unit is controlled by the network management agent program according to the power schedule table and the time information.

13. The power-saving device according to claim 9 wherein the time generator generates the time information associated with the location of the power-saving device.

14. The power-saving device according to claim 9 wherein the time generator is a real time clock.

15. The power-saving device according to claim 9 wherein the power control unit transmits electrical power to the connecting port according to the power-outputting status of the power control unit.

16. The power-saving device according to claim 9 wherein the power control unit interrupts transmission of electrical power to the connecting port according to the power-outputting status of the power control unit.

17. A power-saving method for use with a Power-over-Ethernet system, comprising steps of:
reading out a power schedule table;
reading time information; and
controlling a power-outputting status of a power control unit of the Power-over-Ethernet system according to the power schedule table and the time information.

18. The power-saving method according to claim 17 wherein the power schedule table is adjustable by a user, and includes the date or time of outputting electrical power from the power control unit to the connecting ports or the quantity of electricity to be outputted.

19. The power-saving method according to claim 17 wherein the power control unit transmits electrical power to the connecting port or interrupts transmission of electrical power to the connecting port according to the power-outputting status of the power control unit.

20. The power-saving method according to claim 17 wherein the time information is generated by a time generator, and the time generator is a real time clock.
